(19) United States
(12) Patent Application Publication
(10) Pub. No.: US 2026/0309560 A1
(43) Pub. Date: Oct. 8, 2026

(54) Torque Measurement with Flexible Magnetoresistive Sensors

(71) Applicant: NCTE AG, Oberhaching (DE)

(72) Inventors: Florian Eckschlager, Riemerling (DE); Jürgen Uebbing, Munchen (DE)

(21) Appl. No.: 19/633,097

(22) Filed: Mar. 30, 2026

(30) Foreign Application Priority Data
Apr. 2, 2025 (EP) 25167884.3

(51) Int. Cl. G01L 3/10; G01L 1/12

(52) U.S. Cl. CPC G01L 3/102; G01L 1/125; G01L 3/104

(57) ABSTRACT

A magnetoelastic torque sensor comprises a shaft to which a torque acting about a longitudinal axis of the shaft can be applied and which is magnetized in a first circumferential direction in a first axial section; a first magnetic field sensor device for detecting a magnetic field generated by the first axial section of the shaft outside the shaft and dependent on the applied torque; and an evaluation unit for determining the applied torque from a signal from the first magnetic field sensor device corresponding to the detected magnetic field. The first magnetic field sensor device is provided on a flexible medium and is designed to detect the magnetic field generated by the first axial section completely over 360° around the shaft at each measurement point in time.

### CROSS-REFERENCE TO RELATED APPLICATIONS

This application claims priority to European Patent Application Serial No. EP 25167884.3, filed Apr. 2, 2025, the entire disclosure of which is hereby incorporated by reference.

### TECHNICAL FIELD

The invention relates to a magnetoelastic torque sensor and a method for determining a torque applied to a shaft using a magnetoelastic torque sensor.

### BACKGROUND

Magnetoelastic torque sensors are based on the effect of a change in magnetic permeability upon a change in length (reverse magnetostriction). There are passive and active magnetoelastic sensors. The present patent application relates to passive magnetoelastic sensors based on pre-magnetization of the measuring point and measurement of a change in the magnetic field due to an applied load.

Torque sensors based on the (inverse) magnetostrictive effect have the advantage that the torque can be measured without contact by detecting a magnetic field.

Measuring coils can be used to measure magnetic field changes caused by a torque acting on a shaft based on magnetostriction. These measuring coils are mounted contactlessly in relation to a magnetically coded measuring shaft (parallel to the axis of rotation) and detect magnetic field changes that occur due to the magnetoelastic effect under load (inverse magnetostriction). The magnetic field change is directly proportional to the external load (force, torque) and establishes the connection with the torque.

Alternatively, magnetoresistive magnetic field sensors can also be used to measure the magnetic field. One example is an AMR sensor, which can measure the magnetic field strength or its change based on the anisotropic magnetoresistive effect (AMR effect).

However, the torque sensors currently in use have the disadvantages listed below.

The magnetized shaft often exhibits small irregularities in the initial magnetization, which cause a signal detected by the magnetic field sensors to have a component that depends on the current angular position of the shaft relative to the magnetic field sensor. The torque determined from this signal then fluctuates around a mean value, for example, even if the actual applied torque is constant. Ideally, however, the signal would be independent of the angular position so that a (single) correct value for the applied torque can be determined.

Although possibilities have been implemented in which such irregularities in magnetization are also measured and stored in order to calculate the angular dependence using the evaluation software, this preliminary calibration is complex and must be provided separately for each individual sensor. In view of these disadvantages, the object of the present invention is to provide a torque sensor that is not dependent on the angular position of the shaft. However, this calibration, which must be performed in advance, is time-consuming and must be provided separately for each individual sensor.

In view of these disadvantages, the problem of the present invention is to provide a torque sensor that enables simple, accurate, and precise conversion to the applied torque.

### SUMMARY

The invention is based on the problem of at least partially eliminating the aforementioned disadvantages.

This problem is solved by a magnetoelastic torque sensor according to claim 1.

The magnetoelastic torque sensor according to the invention comprises a shaft to which a torque acting about a longitudinal axis of the shaft can be applied and which is magnetized in a first axial section in a first circumferential direction; a first magnetic field sensor device for detecting a magnetic field generated by the first axial section of the shaft, which is dependent on the applied torque, outside the shaft; and an evaluation unit for determining the applied torque from a signal from the first magnetic field sensor device corresponding to the detected magnetic field. The first magnetic field sensor device is provided on a flexible medium and is designed to detect the magnetic field generated by the first axial section completely over 360° around the shaft at each measurement point in time.

Unlike sensors on a rigid medium, the flexible medium enables the magnetic field sensor device to be arranged uniformly at a constant distance from and around the shaft.

Providing the magnetic field sensor device circumferentially around the shaft ensures simultaneous complete detection of the magnetic field generated by the torque due to inverse magnetostriction at any given time. Therefore, a simple, one-time calibration of the torque sensor during manufacture is sufficient to accurately determine the applied torque, regardless of any unevenness in the magnetization in the circumferential direction.

The signal from the first magnetic field sensor device then exhibits good rotational signal uniformity (RSU). RSU is an indicator of the signal change that occurs when a shaft rotates 360° around its longitudinal axis. Ideally, the RSU should be as small as possible, preferably zero. The signal change is caused by non-ideal magnetization of the axial area in the circumferential direction, which leads to rotational asymmetry of the sensor signals when the shaft rotates around its axis. With ideal magnetization, the measured magnetic field and thus the sensor signal would be independent of the angular position of the shaft and dependent only on the applied torque. The measurement of the magnetic field over 360° proposed here eliminates the need for a correction dependent on the relative angular position of the shaft and the magnetic field sensor device.

A further development of the torque sensor according to the invention is that the sensitivity of the first magnetic field sensor device to the detected magnetic field can be even for each angle in the circumferential direction. This leads to a further improvement in the independence of the sensor signal from the angular position.

Another further development of the torque sensor according to the invention is that the shaft has a second axial section which is magnetized in a second circumferential direction that is opposite to the first circumferential direction; and wherein the torque sensor further comprises a second magnetic field sensor device for detecting a magnetic field generated by the second axial section of the shaft outside the shaft, the magnetic field being dependent on the applied torque; wherein the evaluation unit is further configured to determine the applied torque from a signal of the second magnetic field sensor device corresponding to the detected magnetic field; and wherein the second magnetic field sensor device is provided on the flexible medium or on a further flexible medium and is configured to completely detect the magnetic field generated by the second axial section over 360° around the shaft at each measurement point in time. One or more additional magnetized axial sections of the shaft and respective magnetic field sensor devices may also be provided, which are formed on the flexible medium or on additional flexible media and which are capable of completely detecting the respective magnetic field generated by the additional axial sections at every measurement point over 360° around the shaft.

In this way, the accuracy can be further increased and, in particular, constant interference magnetic fields independent of the applied torque can be compensated for/calculated out.

The magnetic field strengths measurable by the magnetic field sensor device can be in the range of ± 10 mT, ± 3 mT, ± 1 mT, ± 300 μT, or ± 100 μT. Therefore, the magnetoelastic torque sensor according to the invention can be operated with low magnetization of the shaft, which causes only low measurement field strengths. For comparison: The field strength of the Earth's magnetic field in Central Europe is approximately 50 μT.

The evaluation unit is also configured to compensate for the influence of an external interfering magnetic field on the determination of the torque from the signals from the first and second magnetic field sensor devices, in particular in real time when the interfering magnetic field changes.

According to another further development, the first and/or second magnetic field sensor device is designed to sum or integrate the magnetic field detected over 360°. This allows, in particular, the signal from the first magnetic field sensor device corresponding to the detected magnetic field to be independent of a relative angular position between the shaft and the first magnetic field sensor device at each measurement point in time.

Another further development is that the first and/or second magnetic field sensor device comprises a respective magnetoresistive sensor device, in particular a magnetoresistive sensor device printed on the flexible medium.

The flexible medium may comprise a polymer substrate, a film, or a paper.

A further embodiment may comprise the magnetoresistive sensor device comprising an xMR sensor element. Here, “xMR” stands in particular for a sensor element based on the effect of giant magnetoresistance (GMR), tunnel magnetoresistance (TMR), colossal magnetoresistance (CMR), extraordinary magnetoresistance (EMR), large magnetoresistance (LMR) or anisotropic magnetoresistance (AMR).

According to yet another embodiment, the flexible medium is fixed around the shaft by means of a holder, for example a plastic holder.

This can be further modified in that the holder is provided as a sleeve formed coaxially with the shaft and the flexible medium is provided on an inner side or an outer side of the sleeve.

The shaft can be a solid or a hollow shaft.

Another further embodiment is that each magnetoresistive sensor device is formed on a separate flexible medium, or the first and second magnetoresistive sensor devices are formed on exactly one flexible medium.

Another further embodiment is that the first and/or second magnetoresistive sensor device comprises two sections in the circumferential direction, each section detecting the generated magnetic field over 180°. In this way, the detection of the generated magnetic field can be divided between two circumferential sections.

Alternatively, magnetoresistive sensor devices may also be used which have several sections, each of which detects less than 360°, approximately 360° or more than 360°. In particular, multiple circumferential windings of the magnetoresistive sensor device may be used. This can further improve the accuracy and uniformity of the magnetic field detection.

According to another further embodiment, the evaluation unit is further configured to compensate for the influence of an external interfering magnetic field on the determination of the torque from the signals of the first and second magnetic field sensor devices, in particular in real time when the interfering magnetic field changes.

This can be further modified in such a way that the external interfering magnetic field comprises the Earth's magnetic field and/or a magnetic field generated by magnetization of the shaft caused by the Earth's magnetic field and/or a magnetic field generated by a permanent magnet in the vicinity of the magnetic field sensor device.

According to another further embodiment, the magnetic field sensor device(s) is/are designed to output a constant signal to the evaluation unit during rotation of the shaft about its longitudinal axis and at a constantly applied torque, in particular independently of any rotational asymmetry of the magnetic field generated by the first and/or second axial section.

Another further embodiment is that the evaluation unit comprises a data memory in which a relationship between the measured magnetic field and the torque applied to the shaft is stored.

The correlation can be stored as a tabular correlation or as a functional correlation. For this purpose, the torque sensor can be calibrated before commissioning by measuring the corresponding magnetic field strengths at a known torque. The functional correlation may, for example, be a linear function that maps the measured magnetic field to the applied torque.

The invention also provides a device comprising a magnetoelastic torque sensor according to the invention or according to one of the further embodiments, wherein the device is a bottom bracket of a bicycle or an e-bike, a motor, a motor test bench, a test bench for high-speed shafts with over 10,000 rpm, a drive unit, a robot, an extruder, a straightening machine, an aircraft, an actuator, a cardan shaft, or a drive shaft.

Further features and exemplary embodiments as well as advantages of the present invention are explained in more detail below with reference to the drawings. It is understood that the embodiments do not limit the scope of the present invention. It is further understood that some or all of the features described below may also be combined with each other in other ways.

### BRIEF DESCRIPTION OF THE DRAWINGS

FIG. 1 shows a first embodiment of the torque sensor according to the present invention.

FIG. 2 shows a second embodiment of the torque sensor according to the present invention.

### DETAILED DESCRIPTION

The magnetoelastic torque sensor according to the invention comprises a shaft to which a torque exerting a force a about a longitudinal axis of the shaft can be applied and which is magnetized in a first axial section in a first circumferential direction; a first magnetic field sensor device adapted to detect a magnetic field generated by the first axial section of the shaft, which is dependent on the applied torque, outside the shaft; and an evaluation unit for determining the applied torque from a signal from the first magnetic field sensor device corresponding to the detected magnetic field. The first magnetic field sensor device is mounted on a flexible medium and is designed to detect the magnetic field generated by the first axial section completely over 360° around the shaft at each measurement point in time.

Unlike sensors on a rigid medium, the flexible medium enables the magnetic field sensor device to be arranged uniformly at a constant distance from and around the shaft.

Providing the magnetic field sensor device circumferentially around the shaft ensures simultaneous complete detection of the magnetic field generated by the torque due to inverse magnetostriction at any given time. Therefore, a simple, one-time calibration of the torque sensor during manufacture is sufficient to accurately determine the applied torque, regardless of any unevenness in the magnetization in the circumferential direction.

The signal from the first magnetic field sensor device then exhibits good rotational signal uniformity (RSU). RSU is an indicator of the signal change that occurs when a shaft rotates 360° around its longitudinal axis. Ideally, the RSU should be as small as possible, preferably zero. The signal change is caused by non-ideal magnetization of the axial area in the circumferential direction, which leads to rotational asymmetry of the sensor signals when the shaft rotates around its axis. With ideal magnetization, the measured magnetic field and thus the sensor signal would be independent of the angular position of the shaft and dependent only on the applied torque. The measurement of the magnetic field over 360° proposed here eliminates the need for a correction dependent on the relative angular position of the shaft and the magnetic field sensor device.

A further development of the torque sensor according to the invention is that the sensitivity of the first magnetic field sensor device to the detected magnetic field can be even for each angle in the circumferential direction. This leads to a further improvement in the independence of the sensor signal from the angular position.

Another further development of the torque sensor according to the invention is that the shaft has a second axial section which is magnetized in a second circumferential direction that is opposite to the first circumferential direction; and wherein the torque sensor further comprises a second magnetic field sensor device for detecting a magnetic field generated by the second axial section of the shaft outside the shaft, the magnetic field being dependent on the applied torque; wherein the evaluation unit is further configured to determine the applied torque from a signal of the second magnetic field sensor device corresponding to the detected magnetic field; and wherein the second magnetic field sensor device is provided on the flexible medium or on a further flexible medium and is configured to completely detect the magnetic field generated by the second axial section over 360° around the shaft at each measurement point in time. One or more additional magnetized axial sections of the shaft and respective magnetic field sensor devices may also be provided, which are formed on the flexible medium or on additional flexible media and which are capable of completely detecting the respective magnetic field generated by the additional axial sections at every measurement point over 360° around the shaft.

In this way, the accuracy can be further increased and, in particular, constant interference magnetic fields independent of the applied torque can be compensated for/calculated out.

The magnetic field strengths measurable by the magnetic field sensor device can be in the range of ± 10 mT, ± 3 mT, ± 1 mT, ± 300 μT, or ± 100 μT. Therefore, the magnetoelastic torque sensor according to the invention can be operated with low magnetization of the shaft, which causes only low measurement field strengths. For comparison: The field strength of the Earth's magnetic field in Central Europe is approximately 50 μT.

The evaluation unit is also configured to compensate for the influence of an external interfering magnetic field on the determination of the torque from the signals from the first and second magnetic field sensor devices, in particular in real time when the interfering magnetic field changes.

According to another further development, the first and/or second magnetic field sensor device is designed to sum or integrate the magnetic field detected over 360°. This allows, in particular, the signal from the first magnetic field sensor device corresponding to the detected magnetic field to be independent of a relative angular position between the shaft and the first magnetic field sensor device at each measurement point in time.

Another further development is that the first and/or second magnetic field sensor device comprises a respective magnetoresistive sensor device, in particular a magnetoresistive sensor device printed on the flexible medium.

The flexible medium may comprise a polymer substrate, a film, or a paper.

A further embodiment may comprise the magnetoresistive sensor device comprising an xMR sensor element. Here, “xMR” stands in particular for a sensor element based on the effect of giant magnetoresistance (GMR), tunnel magnetoresistance (TMR), colossal magnetoresistance (CMR), extraordinary magnetoresistance (EMR), large magnetoresistance (LMR) or anisotropic magnetoresistance (AMR).

According to yet another embodiment, the flexible medium is fixed around the shaft by means of a holder, for example a plastic holder.

This can be further modified in that the holder is provided as a sleeve formed coaxially with the shaft and the flexible medium is provided on an inner side or an outer side of the sleeve.

The shaft can be a solid or a hollow shaft.

Another further embodiment is that each magnetoresistive sensor device is formed on a separate flexible medium, or the first and second magnetoresistive sensor devices are formed on exactly one flexible medium.

Another further embodiment is that the first and/or second magnetoresistive sensor device comprises two sections in the circumferential direction, each section detecting the generated magnetic field over 180°. In this way, the detection of the generated magnetic field can be divided between two circumferential sections.

Alternatively, magnetoresistive sensor devices may also be used which have several sections, each of which detects less than 360°, approximately 360° or more than 360°. In particular, multiple circumferential windings of the magnetoresistive sensor device may be used. This can further improve the accuracy and uniformity of the magnetic field detection.

According to another further embodiment, the evaluation unit is further configured to compensate for the influence of an external interfering magnetic field on the determination of the torque from the signals of the first and second magnetic field sensor devices, in particular in real time in the event the interfering magnetic field changes.

This can be further modified in such a way that the external interfering magnetic field comprises the Earth's magnetic field and/or a magnetic field generated by magnetization of the shaft caused by the Earth's magnetic field and/or a magnetic field generated by a permanent magnet in the vicinity of the magnetic field sensor device.

According to another further embodiment, the magnetic field sensor device(s) is/are designed to output a constant signal to the evaluation unit during rotation of the shaft about its longitudinal axis and at a constantly applied torque, in particular independently of any rotational asymmetry of the magnetic field generated by the first and/or second axial section.

Another further embodiment is that the evaluation unit comprises a data memory in which a relationship between the measured magnetic field and the torque applied to the shaft is stored.

The correlation can be stored as a tabular correlation or as a functional correlation. For this purpose, the torque sensor can be calibrated before commissioning by measuring the corresponding magnetic field strengths at a known torque. The functional correlation may, for example, be a linear function that maps the measured magnetic field to the applied torque.

The invention also provides a device comprising a magnetoelastic torque sensor according to the invention or according to one of the further embodiments, wherein the device is a bottom bracket of a bicycle or an e-bike, a motor, a motor test bench, a test bench for high-speed shafts with over 10,000 rpm, a drive unit, a robot, an extruder, a straightening machine, an aircraft, an actuator, a cardan shaft, or a drive shaft.

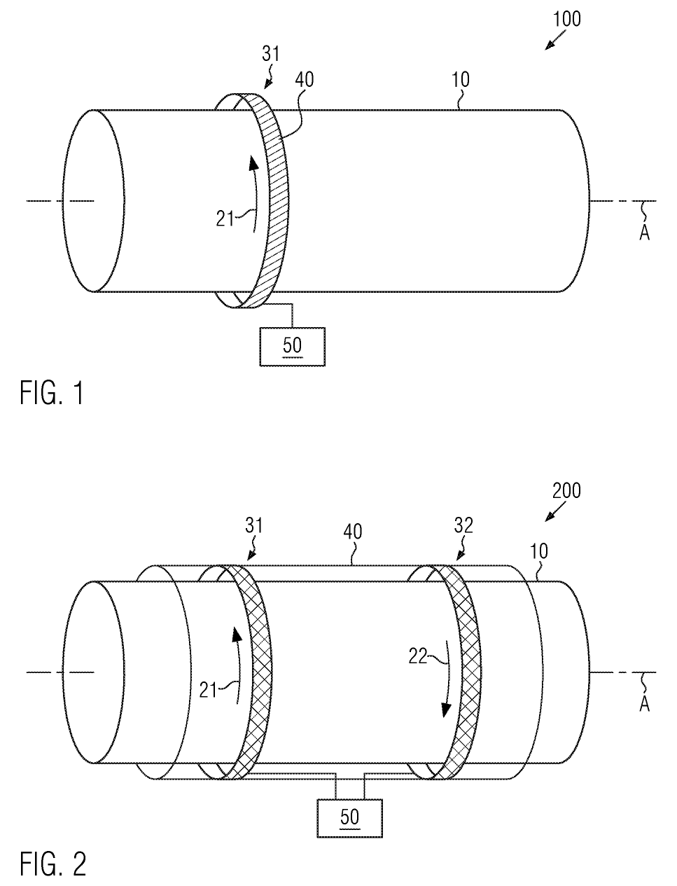

FIG. 1 shows a first embodiment of the magnetoelastic torque sensor 100 according to the present invention.

In this embodiment, the torque sensor 100 according to the invention comprises a shaft 10 to which a torque acting about a longitudinal axis A of the shaft can be applied and which is magnetized in a first circumferential direction in a first axial section 21; a first magnetic field sensor device 31 for detecting a magnetic field generated by the first axial section 21 of the shaft 10, the magnetic field being dependent on the applied torque, outside the shaft 10; and an evaluation unit 50 for determining the applied torque from a signal corresponding to the detected magnetic field, which is generated by the first magnetic field sensor device 31 and received by the evaluation unit 50. The first magnetic field sensor device 31 is provided on a flexible medium 40 and is designed to detect the magnetic field generated by the first axial section 21 completely over 360° around the shaft 10 at each measurement point in time.

The flexible medium 40 allows the magnetic field sensor device 31 to be arranged uniformly at a constant radial distance from the shaft 10 and over 360° around the shaft 10.

The provision of the magnetic field sensor device 31 circumferentially around the shaft 10 ensures simultaneous and complete detection of the magnetic field generated by the first axial section 21 at any given time.

The signal from the first magnetic field sensor device then exhibits good rotational signal uniformity (RSU). The 360° measurement of the magnetic field proposed here eliminates the need for a correction dependent on the relative angular position of the shaft 10 and the magnetic field sensor device 31.

The sensitivity of the first magnetic field sensor device 31 to the detected magnetic field in the circumferential direction is ideally uniform for every angle around the shaft 10. This results in the sensor signal being largely independent of the angular position with uniform distribution of the areas of the first magnetic field sensor device 31 that are sensitive to the magnetic field.

FIG. 2 shows a second embodiment of the torque sensor 200 according to the invention.

The difference between the torque sensor 200 of the present invention according to this second embodiment and the torque sensor 100 of the present invention according to FIG. 1 is that the shaft 10 has a second axial section 22 which is magnetized in a second circumferential direction opposite to the first circumferential direction; wherein the torque sensor 200 further comprises a second magnetic field sensor device 32 for detecting a magnetic field generated by the second axial section 22 of the shaft 10 outside the shaft 10, the magnetic field being dependent on the applied torque; wherein the evaluation unit 50 is further configured to determine the applied torque from a signal from the second magnetic field sensor device 32 corresponding to the detected magnetic field; and wherein the second magnetic field sensor device 32 is provided on the flexible medium or on a further flexible medium and is configured to completely detect the magnetic field generated by the second axial section 22 around the shaft 10 over 360° at each measurement point in time.

The embodiments relating to the first axial section 21 and the first magnetic field sensor device 31 of the first embodiment apply here accordingly to the additional second axial section 22 and the additional second magnetic field sensor device 32 of the second embodiment.

The embodiments shown are merely examples, and the full scope of the present invention is defined by the claims.

What is claimed is:

1. A magnetoelastic torque sensor comprising:
a shaft to which a torque exerting a force about a longitudinal axis of the shaft can be applied and which is magnetized in a first circumferential direction in a first axial section;
a first magnetic field sensor device for detecting a magnetic field generated by the first axial section of the shaft outside the shaft and dependent on the applied torque; and
an evaluation unit for determining the applied torque from a signal of the first magnetic field sensor device corresponding to the detected magnetic field;
wherein the first magnetic field sensor device is provided on a flexible medium and is adapted to detect the magnetic field generated by the first axial section completely over 360° around the shaft at each measurement point in time.

2. The magnetoelastic torque sensor according to claim 1, wherein a sensitivity of the first magnetic field sensor device to the detected magnetic field is even in the circumferential direction.

3. The magnetoelastic torque sensor according to claim 1, wherein the shaft comprises a second axial section that is magnetized in a second circumferential direction that is opposite to the first circumferential direction; and
wherein the torque sensor further comprises a second magnetic field sensor device for detecting a magnetic field generated by the second axial section of the shaft outside the shaft and dependent on the applied torque;
wherein the evaluation unit is further configured to determine the applied torque from a signal of the second magnetic field sensor device corresponding to the detected magnetic field; and
wherein the second magnetic field sensor device is provided on the flexible medium or on a further flexible medium and is configured to detect the magnetic field generated by the second axial section completely over 360° around the shaft at each measurement point in time.

4. The magnetoelastic torque sensor according to claim 1, wherein one or both of the first magnetic field sensor device and a second magnetic field sensor device is configured to sum or integrate the magnetic field detected over 360°, such that at each measurement point in time, the signal of the first magnetic field sensor device corresponding to the detected magnetic field is independent of a relative angular position between the shaft and the first magnetic field sensor device.

5. The magnetoelastic torque sensor according to claim 1, wherein one or both of the first magnetic sensor device and a second magnetic field sensor device comprises a respective magnetoresistive sensor device, in particular a magnetoresistive sensor device printed on the flexible medium.

6. The magnetoelastic torque sensor according to claim 5, wherein the magnetoresistive sensor device comprises an xMR sensor element, in particular a GMR, TMR, CMR, EMR, LMR, or AMR sensor element; and/or wherein the flexible medium comprises a polymer substrate, a film, or a paper.

7. The magnetoelastic torque sensor according to claim 1, wherein the flexible medium is fixed around the shaft by means of a holder, for example a plastic holder.

8. The magnetoelastic torque sensor according to claim 7, wherein the holder is provided as a sleeve formed coaxially with the shaft and the flexible medium is provided on an inner side or an outer side of the sleeve.

9. The magnetoelastic torque sensor according to claim 3, wherein each magnetoresistive sensor device is formed on a separate flexible medium, or wherein a first magnetoresistive sensor device and a second magnetoresistive sensor devices are formed on exactly one flexible medium.

10. The magnetoelastic torque sensor according to claim 9, wherein one or both of the first magnetoresistive sensor device and the second magnetoresistive sensor device each comprise two or more sections in the circumferential direction, each section detecting the generated magnetic field over less than 360°, in particular over 180°, or wherein the first and/or second magnetoresistive sensor device is provided multiple times around the shaft.

11. The magnetoelastic torque sensor according to claim 3, wherein the evaluation unit is further configured to compensate an influence of an external interfering magnetic field on the determination of the torque from the signals of the first and second magnetic field sensor devices, in particular in real time in an event of a change in the interfering magnetic field, in particular wherein the external interfering magnetic field comprises an Earth's magnetic field and/or a magnetic field generated by magnetization of the shaft caused by the Earth's magnetic field and/or a magnetic field generated by a permanent magnet in a vicinity of the magnetic field sensor device.

12. The magnetoelastic torque sensor according to claim 1, wherein one or both of the first magnetic field sensor device and a second magnetic field sensor device is/are designed to output a constant signal to the evaluation unit during rotation of the shaft about its longitudinal axis and at a constant applied torque, in particular independently of any rotational asymmetry of the magnetic field generated by one or both of the first axial section and the second axial section.

13. The magnetoelastic torque sensor according to claim 1, wherein the evaluation unit comprises a data memory in which a relationship between the measured magnetic field and the torque applied to the shaft is stored.

14. The magnetoelastic torque sensor according to claim 1, wherein the shaft is rotatably mounted with respect to the axis.

15. A device comprising the magnetoelastic torque sensor according to claim 1, wherein the device is a bottom bracket of a bicycle or an e-bike, a motor, a motor test bench, a test bench for high-speed shafts with more than 10,000 rpm, a drive unit, a robot, an extruder, a straightening machine, an aircraft, an actuator, a cardan shaft, or a drive shaft.
